(19) United States
(12) Patent Application Publication
(10) Pub. No.: US 2010/0133961 A1
(43) Pub. Date: Jun. 3, 2010

(54) CONTROLLER-INTEGRATED ROTATING ELECTRICAL MACHINE

(75) Inventors: Yuji SHIRAKATA, Chiyoda-ku (JP); Masao KIKUCHI, Chiyoda-ku (JP); Hitoshi ISODA, Chiyoda-ku (JP); Takamasa ASAI, Chiyoda-Ku (JP); Katsuya TSUJIMOTO, Chiyoda-Ku (JP)

Correspondence Address: SUGHRUE MION, PLLC, 2100 PENNSYLVANIA AVENUE, N.W., SUITE 800, WASHINGTON, DC, 20037, US

(73) Assignee: MITSUBISHI ELECTRIC CORPORATION, Tokyo (JP)

(21) Appl. No.: 12/430,537

(22) Filed: Apr. 27, 2009

(30) Foreign Application Priority Data
Dec. 3, 2008 (JP) 2008-308670

(51) Int. Cl. H02K 11/00

(52) U.S. Cl. 310/68 B

(57) ABSTRACT

A controller-integrated rotating electrical machine includes a rotating electrical machine main body having a stator winding and a field winding and provided with a rotation detector that detects a rotation angle of a rotation shaft, a power circuit that controls a current flowing into the stator winding according to a detection output of the rotation detection portion, a field switching circuit that controls a current to flow into the field winding, and a capacitor connected in parallel with the power circuit and the field switching circuit. Both ends of the capacitor portion are connected to an external battery. The capacitor is disposed in closer proximity to the field switching circuit than the rotation detector, and connected to the field switching circuit via a common connection terminal. Noises superimposed on the rotation detection portion are thus reduced.

### BACKGROUND OF THE INVENTION

1. Field of the Invention

The present invention relates to a controller-integrated rotating electrical machine that is a field winding type rotating electric machine equipped with a controller as an integral part thereof.

2. Background Art

JP-A-2006-187094 discloses a motor generator having a motor generator main body in which an inverter circuit portion and a control circuit portion are incorporated. According to this motor generator, wiring can be streamlined by forming signal lines from a pattern on a control board. In addition, by spacing apart a signal line of a field circuit and a channel through which a current of the field circuit flows from a rotor and a stator, a control circuit of an inverter and circuits and parts associated with this control circuit become less susceptible to noises resulting from a leakage flux from the rotor and the stator.

JP-A-2008-5676 discloses a controller-integrated rotating electrical machine incorporating a stator current switching circuit portion, a field current switching portion, and a controller of these circuit portions. This reference describes a configuration of the field switching circuit portion and a configuration in which a capacitor portion is mounted on a circuit board on which the field switching circuit portion is to be mounted.

In the case of the rotating electrical machine formed by integrating the motor generator and the inverter portion, however, it is not only that the control circuit of the inverter and circuits and parts associated with this control circuit are susceptible to noises resulting from a leakage flux from the rotor and the stator, but also that noises resulting from a magnetic flux generated from a loop of the circuits by an abrupt current change in the field switching element are superimposed thereon. In particular, this rotating electrical machine has a problem that an angular error occurs when noises are superimposed on an output signal of a resolver for rotation angle detection provided inside the rotating electric machine main body.

Wiring channels among circuits and parts are crucial in order to suppress the occurrence of such a magnetic flux. JP-A-2006-180794 supra, however, is silent about a battery terminal and wiring channels. JP-A-2008-5676 supra describes the configuration of the field switching circuit portion and the shape designed to mount the capacitor portion on the circuit board on which the field switching circuit portion is to be mounted. This reference, however, is also silent about the position of a battery terminal, the layout with respect to the capacitor portion, and a connection method, and fails to teach an effective countermeasure to reduce noises that will be superimposed on the resolver.

### SUMMARY OF THE INVENTION

In order to solve the problems discussed above, the invention has an object to provide a controller-integrated rotating electrical machine capable of reducing noises that will be superimposed on a rotation detection portion, such as a resolver, by devising wiring channels among circuits and components.

A controller-integrated rotating electrical machine according to an aspect of the invention includes a rotating electrical machine main body having a stator winding and a field winding and provided with a rotation detection portion that detects a rotation angle of a rotation shaft by combining a winding and a core, a power circuit portion that controls a current to be flown into the stator winding according to a detection output of the rotation detection portion, a field switching circuit portion that controls a current to be flown into the field winding, and a capacitor portion connected in parallel with the power circuit portion and the field switching circuit portion, in such a manner that both ends of the capacitor portion are connected to an external battery. The capacitor portion is disposed in closer proximity to the field switching circuit portion than the rotation detection portion and is connected to the field switching circuit portion via a common connection terminal.

According to the controller-integrated rotating electrical machine of the invention, inductive noises generated by an abrupt current change at the switching of the field switching circuit portion can be reduced by making a wiring loop from the capacitor portion to the field switching circuit portion smaller. It thus becomes possible to prevent a malfunction of the controller by reducing noises that will be superimposed on the rotation detection portion.

The foregoing and other object, features, aspects, and advantages of the present invention will become more apparent from the following detailed description of the present invention when taken in conjunction with the accompanying drawings.

### BRIEF DESCRIPTION OF THE DRAWINGS

FIG. 1 is a longitudinal cross section showing a controller-integrated rotating electrical machine according to a first embodiment of the invention;

FIG. 2 is a main circuit diagram of the controller-integrated rotating electrical machine according to the first embodiment;

FIG. 3 is a partial cross-sectional side view showing a wiring channel in the controller-integrated rotating electrical machine according to the first embodiment;

FIG. 4 is a partial cross-sectional side view with a longitudinal cross section of a major portion showing the wiring channel in the controller-integrated rotating electrical machine according to the first embodiment;

FIG. 5 is an exploded perspective view of a major portion according to the first embodiment;

FIG. 6 is a partial cross-sectional side view showing another example of the wiring channel in the controller-integrated rotating electrical machine according to the first embodiment;

FIG. 7 is a partial cross-sectional side view with a longitudinal cross section of a major portion showing the another example of the wiring channel in the controller-integrated rotating electrical machine according to the first embodiment;

FIG. 8 is a longitudinal cross section of a major portion showing a field switching circuit portion in a controller-integrated rotating electrical machine according to a second embodiment of the invention;

FIG. 9 is a partial cross-sectional side view with a longitudinal cross section of a major portion showing a wiring channel in the controller-integrated rotating electrical machine according to the second embodiment of the invention;

FIG. 10 is a partial cross-sectional side view showing a wiring channel in a controller-integrated rotating electrical machine according to a third embodiment of the invention; and

FIG. 11 is a partial cross-sectional side view showing another example of the wiring channel in the controller-integrated rotating electrical machine according to the third embodiment.

### DESCRIPTION OF THE PREFERRED EMBODIMENTS

### First Embodiment

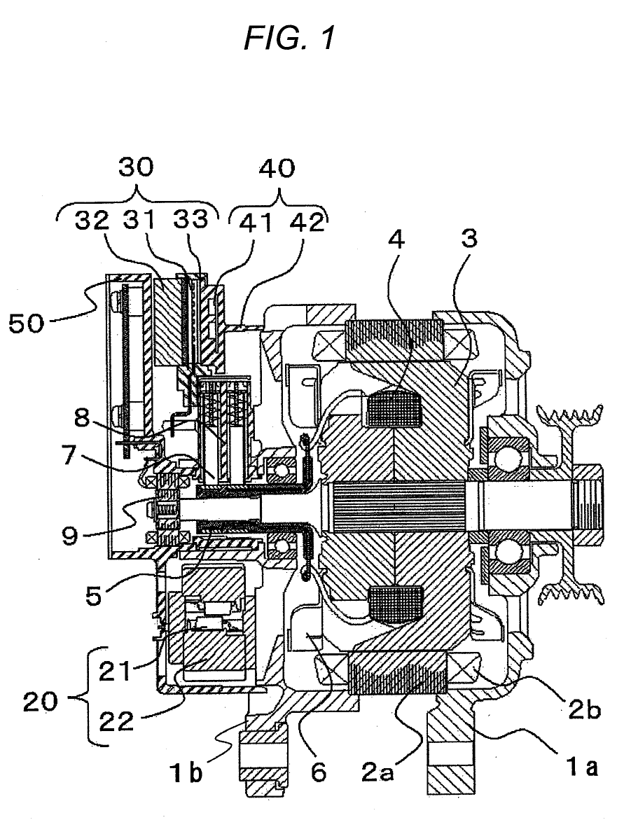

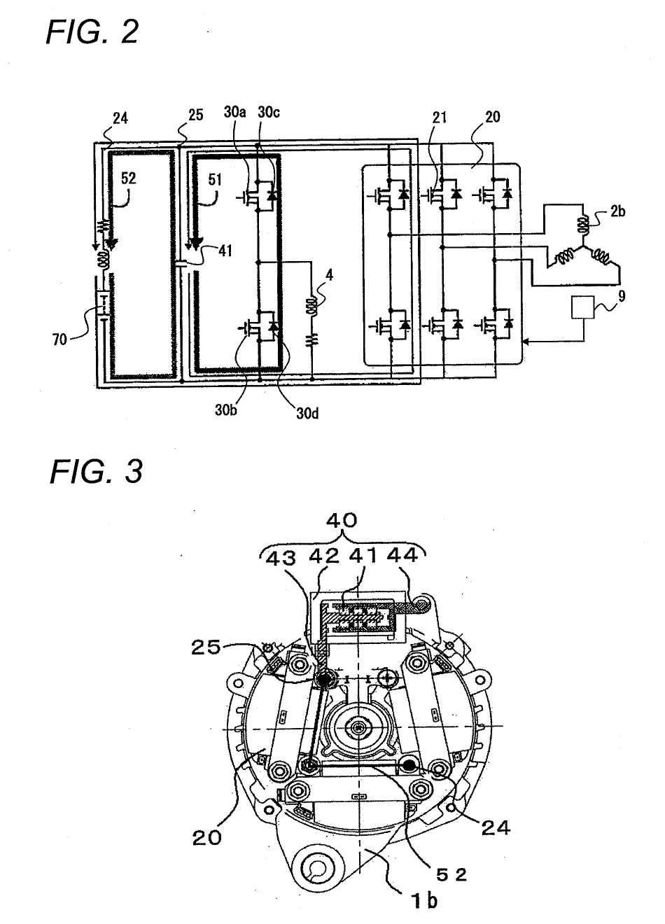

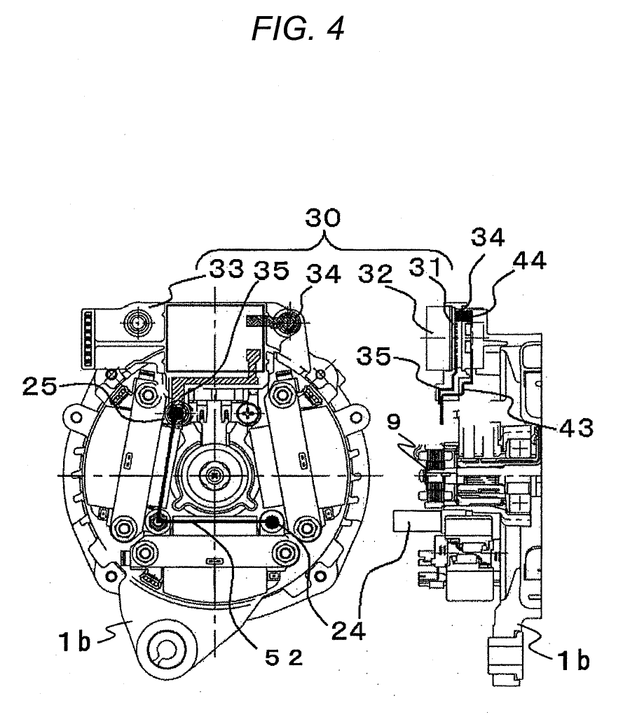

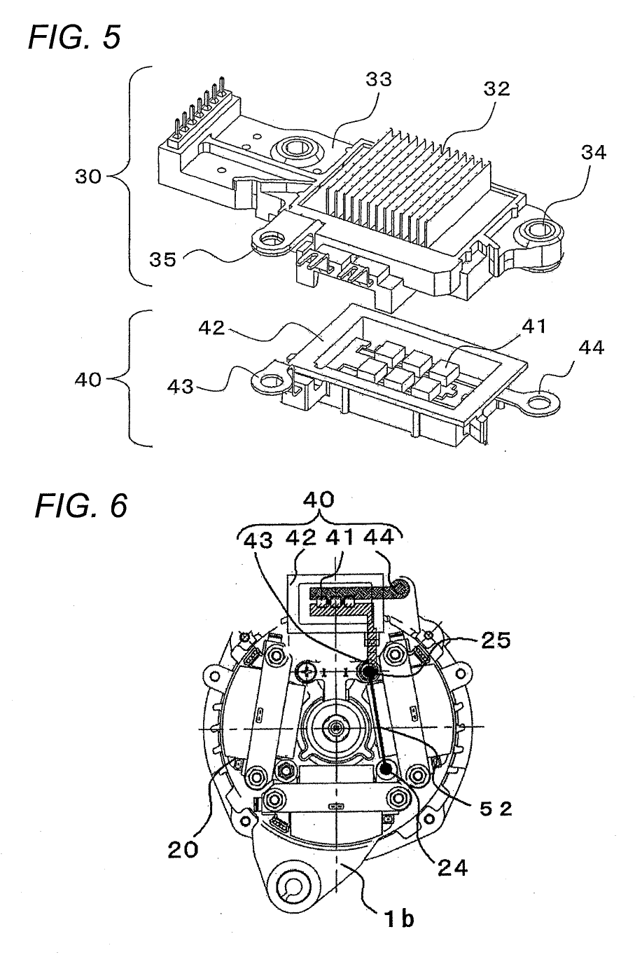

FIG. 1 through FIG. 5 are views showing a controller-integrated rotating electrical machine according to a first embodiment of the invention. FIG. 1 is a longitudinal cross section. FIG. 2 is a main circuit diagram. FIG. 3 is a partial cross-sectional side view showing a wiring channel. FIG. 4 is a partial cross-sectional side view with a longitudinal cross section of a major portion showing the wiring channel. FIG. 5 is an exploded perspective view of a major portion.

Referring to FIG. 1, the controller-integrated rotating electrical machine has a stator 2a and a rotor 3 each supported on a pair of brackets 1a and 1b. The rotor 3 is provided with a field winding 4 to generate a magnetomotive force, a slip ring 5, and a cooling fan 6.

At the rear of the bracket 1b on the pulley opposite side, a brush holder 8 having a brush 7 in contact with the slip ring 5, a power circuit portion 20 that supplies a stator winding 2b with an AC current, a field switching circuit portion 30 that supplies the field winding 4 with a current, and a capacitor portion 40 are separately mounted.

A case 50 storing a resolver 9, which is a rotation detecting portion that detects a rotation angle, is disposed at the rear of the power circuit portion 20 and the field switching circuit portion 30 in the rotation shaft direction.

The power circuit portion 20 is formed in such a manner that a semiconductor switching element 21 for power circuit that supplies the stator winding 2b with a current is mounted on a heat sink 22 for cooling power circuit. As is shown in FIG. 2, it controls a current to be flown into the stator winding 2b by controlling an operation of the semiconductor switching element 21 connected to a battery 70 according to a detection output of the resolver 9.

The power circuit portion 20 is provided with a battery connection terminal 24 to be connected to a battery terminal, and a P connection terminal 25 to be connected to a capacitor P (+) terminal 43 of the capacitor portion 40 and a field P terminal 35 of the field switching circuit 30 (see FIG. 3 and FIG. 4).

The field switching circuit portion 30 is formed by joining a circuit board 31 on which are mounted semiconductor field switching elements 30a and 30b that supply the field winding 4 with a current, flywheel diodes 30c and 30d, and a control IC (not shown) to a field cooling heat sink 32 and also to a resin case 33. Different from an electrical machine, the semiconductor field switching elements 30a and 30b use MOSFETs, which are active elements, and each is connected to a capacitor 41 of the capacitor portion 40 via a power line, such as a bus bar (see FIG. 2). As the circuit board 31, for example, a ceramic substrate or a metal substrate is used.

The capacitor portion 40 is formed by joining the capacitor 41 to a resin case 42 in which wiring materials are inserted.

The field switching circuit portion 30 and the capacitor portion 40 are separately mounted on the bracket 1b. The P terminal of each is attached to the P connection terminal 25 provided to the power circuit portion 20 and the N (−) terminal of each is connected to the bracket 1b (see FIG. 3 and FIG. 4).

As is shown in FIG. 2, there are two wiring loops within a main circuit in the controller-integrated rotating electrical machine. One is a field-to-capacitor loop 51 between the field switching elements 30a and 30b and the capacitor 41, and the other is a battery-to-capacitor loop 52 between the battery 70 and the capacitor 41.

The controller-integrated rotating electrical machine requires the brush holder 8 having the brush 7 for supplying the field winding 4 with a current. To enable the field switching circuit portion 30 to supply the field winding 4 with a current through the brush 7, it is preferable that the field switching circuit portion 30, the brush 7, and the brush holder 8 are disposed in close proximity to one another.

Meanwhile, the bracket 1b protrudes around the resolver 9 so as to hold the case 50, and this protruding portion serves as an electromagnet shield member at the occurrence of an eddy current. Noises generated during the operation of the field switching elements 30a and 30b can be thus reduced. A magnetic field, however, leaks through an opening in a brush insertion portion and reaches the resolver 9. Accordingly, noises generated during the operation of the field switching elements 30a and 30b are unavoidably superimposed on the resolver 9. Hence, in order to reduce noises that will be superimposed on the resolver 9, it is necessary to reduce magnetic fields generated from the field switching circuit portion 30.

In addition, with a purpose to control a current supplied to the field winding 4 from the field switching circuit portion 30 at a high degree of accuracy, the PWM method is adopted as a control method. According to this method, however, the switching frequency of the field switching elements 30a and 30b is increased significantly in comparison with the rectangular pulse conduction method. Noises are therefore superimposed on a detection output signal of the resolver 9 more frequently.

This is attributed to a magnetic field that develops in the field-to-capacitor loop 51 with an abrupt change of the current flowing in the field circuit at the switching. A magnetic field develops more often as the number of switching times increases, and noises are superimposed on the resolver 9 more frequently. Hence, in order to reduce the noises, it is necessary to suppress the development of a magnetic field by making the field-to-capacitor loop 51 shorter.

In the following, a description will be given to a configuration to shorten the field-to-capacitor loop 51 by disposing the field switching circuit portion 30 and the capacitor circuit portion 40 in close proximity to each other.

The both circuit portions are disposed in close proximity to each other in order to shorten the field-to-capacitor loop 51. As a method of disposing these components, at least the capacitor portion 40 is disposed in close proximity to the field switching circuit portion 30 by disposing the capacitor portion 40 and the field switching circuit portion 30 one on top of the other on the bracket 1b in the axial direction as is shown in FIG. 1.

The P(+) and N(−) connection position of the field switching circuit portion 30 and the capacitor portion 40 is located immediately outside of the field switching circuit portion 30 and the capacitor portion 40. Further, on the P side of the connection terminal, a flange portion is provided to each of the power circuit portion 20, the field switching circuit portion 30, and the capacitor portion 40 to form the P connection terminal 25, the field P terminal 35, and the capacitor P terminal 43, respectively, and these terminals are connected at one point (see FIG. 3, FIG. 4, and FIG. 5).

On the N side of the connection terminal, a flange is provided to each of the field switching circuit portion 30 and the capacitor portion 40 to form a field N terminal 34 and a capacitor N terminal 44, respectively. These terminals are also connected at one point and fixed to the bracket 1b as well at this time (see FIG. 3, FIG. 4, and FIG. 5).

As has been described, by disposing the capacitor portion 40 and the field switching circuit portion 30 one on top of the other in the axial direction and by collecting the N terminals, which are attached to the bracket at different points in the related art, at one point, not only can the wiring channel running on the bracket 1b be shorter, but also the channel in the field switching circuit portion 30 and the channel in the capacitor portion 40 can be the wirings parallel to each other. This results in a reduction of noises.

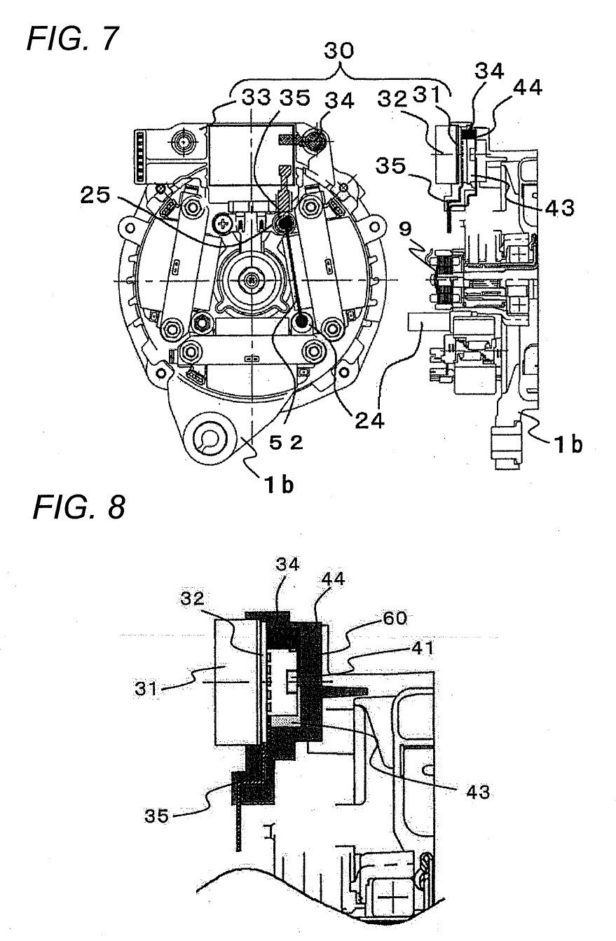

As are shown in FIG. 6 and FIG. 7, in a case where the positions of the field P terminal 35, the capacitor P terminal 43, and the P connection terminal 25 of the power circuit portion 20 are changed so that they come into closer proximity to one another, the wiring channel of the battery-to-capacitor loop 52 can be shortened further. It is therefore possible to reduce noises further.

As has been described, according to the first embodiment, the controller-integrated rotating electric machine includes the rotating electrical machine main body having the stator winding 2b and the field winding 4 and provided with a rotation detection portion, such as the resolver 9, that detects a rotation angle of the rotation shaft by combining a winding and a stator, the power circuit portion 20 that controls a current to be flown into the stator winding according to a detection output of the rotation detection circuit, the field switching circuit portion 30 that controls a current to be flown into the field winding, and the capacitor portion 40 connected in parallel with the power circuit portion 20 and the field switching circuit portion 30, in such a manner that the both ends of the capacitor portion 40 are connected to the external battery 70. The capacitor portion 40 is disposed in closer proximity to the field switching circuit portion 30 than the rotation detection portion and is also connected to the field switching circuit portion 30 via a common connection terminal. This configuration makes it possible to shorten the wiring channel in the field-to-capacitor loop 51 between the field switching circuit portion 30 and the capacitor portion 40. Noises that will be superimposed on the rotation detection portion, such as the resolver 9, can be thus reduced.

In addition, the field switching circuit portion 30 and the capacitor portion 40 are provided as separate components. It is therefore possible to change or combine parts to be used according to the specifications of the controller-integrated rotating electrical machine.

### Second Embodiment

The wiring loop in the field-to-capacitor loop 51 can be shortened by integrating the field switching circuit portion 30 and the capacitor portion 40 of the first embodiment above into one piece, which results in a reduction of noises. In this embodiment, as a method of integrating the field switching circuit portion 30 and the capacitor portion 40 into one piece, as is shown in FIG. 8, a case 60 accommodating the capacitor 41 is used and the circuit board 31 on which are mounted the field switching elements 30a and 30b is attached to the case 60 as if the lid is put thereon. This configuration can reduce an area between the capacitor 41 and the circuit board 31.

The circuit board 31 on which are mounted the field switching elements 30a and 30b is soldered to the terminals inside the case 60. Using the soldering makes it possible to attach the terminals directly onto the circuit board 31. The field-to-capacitor loop 51 can be thus shortened.

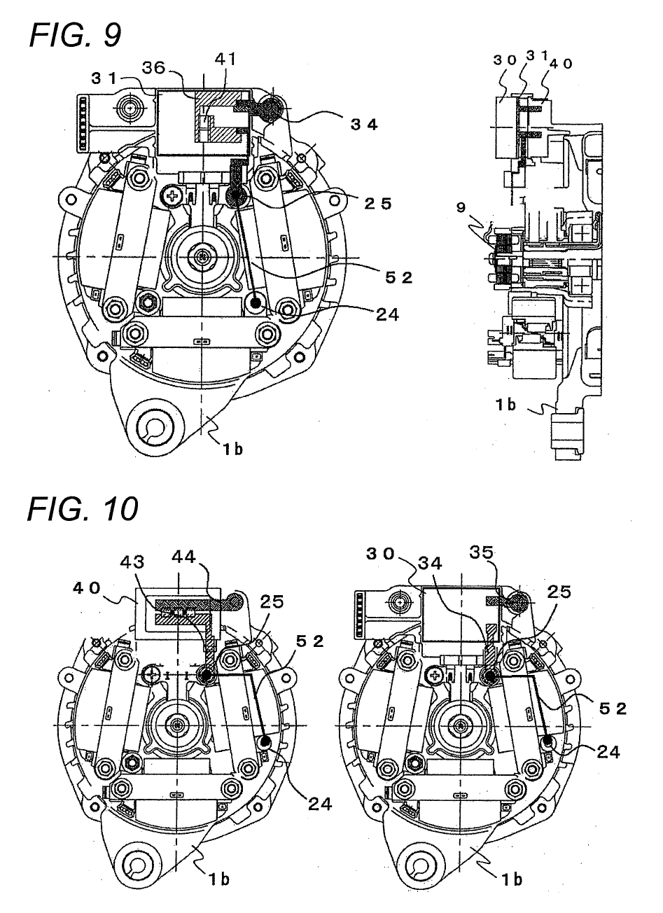

Further, as is shown in FIG. 9, by mounting the capacitor 41 directly onto a wiring pattern 36 on the circuit board 31 used for the field switching circuit portion 30, it is possible to shorten the field-to-capacitor loop 51 between the field switching elements 30a and 30b and the capacitor 41. Further, magnetic field developing directions can be aligned into a single direction. In particular, when the PWM method is adopted as the control method, switching noises can be reduced by making the field-to-capacitor loop 51 shorter. Noises that will be superimposed can be thus reduced.

In addition, noise can be also reduced by setting the position of the circuit board 31 with respect to the resolver winding so that the direction of a magnetic field developed from the circuit board 31 becomes perpendicular to the resolver winding.

In FIG. 9, the circuit board 31 is attached perpendicularly to the axial direction of the rotating electrical machine and is set at the position at which the magnetic field becomes perpendicular to the resolver winding. It should be appreciated, however, that the circuit board 31 can be attached parallel to the axial direction. In this case, too, the circuit board 31 is set at the position at which the magnetic field becomes perpendicular to the resolver winding.

According to the second embodiment, by mounting the capacitor 41 within the circuit board 31 so as to form an integral one piece, it becomes possible to align magnetic field developing directions in the field-to-capacitor loop 51 into a single direction. Also, the circuit board 31 is provided so that the direction of a magnetic field becomes perpendicular to the resolver winding, which results in a reduction of noises.

### Third Embodiment

In this embodiment, the battery-to-capacitor loop 52, which is the wiring channel between the battery connection terminal 24 and the capacitor P terminal 43, can be shortened by moving the battery connection terminal 24 of the first and second embodiments above in an outer peripheral direction of the rotating electrical machine. The battery-to-capacitor loop 52 can be thus spaced apart from the resolver 9, which results in a reduction of noises.

In contrast to the battery-to-capacitor loop 52 from the battery connection terminal 24 to the capacitor P terminal 43 of FIG. 1, the battery-to-capacitor loop 52 of FIG. 10 is shortened by providing the capacitor P terminal 43 on the side of the battery terminal. Noises generated from the wiring loop can be thus reduced.

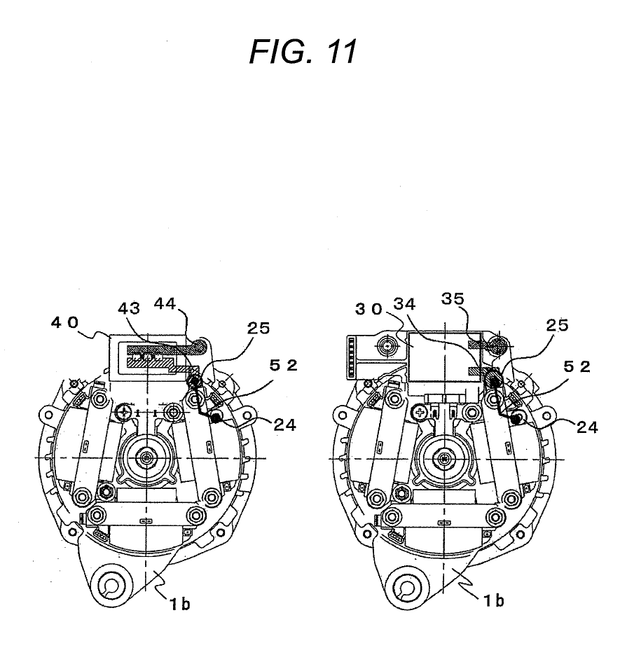

Further, by moving the battery connection terminal 24 toward the outer periphery of the rotating electrical machine as is shown in FIG. 11, the battery-to-capacitor loop 52 can be spaced apart from the resolver 9. Noises can be thus reduced.

Also, as is shown in FIG. 11, besides moving the battery connection terminal 24 toward the outer periphery of the rotating electrical machine, by also disposing the battery connection terminal 24 closer to the capacitor P terminal 43, the battery-to-capacitor loop 52 can be shortened further, which results in a reduction of noises.

According to the third embodiment, it is possible to shorten the wiring loop further by disposing the battery connection terminal 24 on the outer peripheral side of the rotating electrical machine so that it is disposed closer to the capacitor P terminal 43. Noises can be thus reduced.

Various modifications and alterations of this invention will be apparent to those skilled in the art without departing from the scope and spirit of this invention, and it should be understood that this is not limited to the illustrative embodiments set forth herein.

What is claimed is:

1. A controller-integrated rotating electrical machine, comprising:
a rotating electrical machine main body having a stator winding and a field winding and provided with a rotation detection portion that detects a rotation angle of a rotation shaft by combining a winding and a core, a power circuit portion that controls a current to be flown into the stator winding according to a detection output of the rotation detection portion, a field switching circuit portion that controls a current to be flown into the field winding, and a capacitor portion connected in parallel with the power circuit portion and the field switching circuit portion, in such a manner that both ends of the capacitor portion are connected to an external battery,
wherein the capacitor portion is disposed in closer proximity to the field switching circuit portion than the rotation detection portion and is connected to the field switching circuit portion via a common connection terminal.

2. The controller-integrated rotating electrical machine according to claim 1, wherein:
on a P side of the connection terminal, a flange portion is provided to each of the power circuit portion, the field switching circuit portion, and the capacitor portion to form a P connection terminal, a field P terminal, and a capacitor P terminal, respectively, all of which are connected at one point.

3. The controller-integrated rotating electrical machine according to claim 1, wherein:
on an N side of the connection terminal, a flange portion is provided to each of the field switching circuit portion and the capacitor portion to form a field N terminal and a capacitor N terminal, respectively, both of which are connected at one point.

4. The controller-integrated rotating electrical machine according to claim 1, further comprising:
a case in which the capacitor portion and the field switching circuit portion are accommodated integrally as one piece.

5. The controller-integrated rotating electrical machine according to claim 4, wherein:
the capacitor portion and the field switching circuit portion are electrically connected to each other inside the case.

6. The controller-integrated rotating electrical machine according to claim 4, wherein:
the capacitor portion is mounted on a circuit board that is accommodated in the field switching circuit portion.

7. The controller-integrated rotating electrical machine according to claim 1, wherein:
an external connection terminal to connect the capacitor portion to the battery is provided on an outer peripheral side of the rotating electrical machine main body spaced apart from the rotation detection portion.

8. The controller-integrated rotating electrical machine according to claim 7, wherein:
the external connection terminal is disposed in close proximity to the capacitor portion.
